(19) United States
(12) Patent Application Publication
(10) Pub. No.: US 2013/0325605 A1
(43) Pub. Date: Dec. 5, 2013

(54) LEVERAGING A SOCIAL NETWORK FOR TARGETED ADVERTISING

(71) Applicants: David Michael Callaghan, Redmond, WA (US); Chandrasekhar Nukala, Santa Clara, CA (US)

(72) Inventors: David Michael Callaghan, Redmond, WA (US); Chandrasekhar Nukala, Santa Clara, CA (US)

(73) Assignee: Microsoft Corporation, Redmond, WA (US)

(21) Appl. No.: 13/489,112

(22) Filed: Jun. 5, 2012

(51) Int. Cl. G06Q 30/02

(52) U.S. Cl. 705/14.53; 705/14.66

(57) ABSTRACT

A computer-implemented method of advertising for electronic commerce gathers information from a user's social network for the purpose of generating advertisements that are directly targeted to the user, thereby providing a customized shopping experience for the user. Ads can also be directly targeted to the user's contacts. The information can be user profile data, purchase data, or a combination thereof. Further, the information can pertain to the user, the user's social networking contacts, or groups within the social network that include a subset of the user's contacts who share a common interest. The information can be aggregated and stored on a server computer and group statistics can be extracted from the data, while maintaining individuals' anonymity. An aggregate data set can then be used to generate a targeted advertisement for presentation by an advertising server to the user or the user's contacts, via an electronic device.

### FIELD

The present application relates generally to online social networks, and, more particularly to targeted advertising using a social network.

### BACKGROUND

Online retailers currently use customers' Internet order histories to suggest future purchase options. In addition, it is now possible to monitor a customer's web browsing patterns and purchasing behaviors throughout the Internet marketplace in order to anticipate the needs and desires of that customer, so that advertisements or recommendations of purchase items (e.g., goods and services) can be accurately and directly targeted to receptive individuals. In this way, online retailers can more successfully match products to customers.

As the Internet evolves, social networks (e.g., Facebook, Linked-In, MySpace, and the like), which are funded primarily through on-screen advertisements, are becoming more intertwined with electronic commerce at the transaction level. For example, if customers locate desirable products online, the customers can “share” these finds with some or all of their social media contacts, by simply clicking on an icon to automatically broadcast a “thumbs-up” vote of support for the product. In this way, each individual transaction, as it occurs in the marketplace, can automatically and simultaneously trigger multiple referrals to target customers with shared interests, thus effectively penetrating the veil of private social network sites. By encouraging such networked referrals, the web retailer begins to leverage the power of private social networks to market items more efficiently.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Although disseminating ads through social networks is helpful to retailers, extracting information from the social network and using the information for direct marketing to individuals throughout the electronic marketplace is an even more effective way to leverage the related habits of members belonging to groups within a social network to augment sales. For example, analyzing data from a social network to recognize habits shared among members of a common group can be valuable in customizing the e-commerce marketplace for each of the members. Advertisers and retail marketplaces can also leverage social network-related purchasing histories, while applying business logic to correlate these histories with a potential customer's associations, to more effectively target products and services to match the customer's desires and result in a purchasing decision.

In one example, a computer-implemented method of sustaining a dynamic marketplace for electronic commerce gathers information from a user's social network for the purpose of generating advertisements that are directly targeted to the user, thereby providing a customized shopping experience for the user. In a second example, the information can be used to generate a direct advertising presentation in the form of a customized virtual retail marketplace whose appearance, products, and services have a “look and feel” targeted specifically to the user thereby providing a customized shopping experience for the user. In a third example, the ads are directly targeted to the user's contacts. In a third example, a computer-implemented method of sustaining a dynamic marketplace for electronic commerce gathers information from a user's social network for the purpose of generating a customized online retail marketplace whose appearance, products and services are targeted to the user thereby providing a customized shopping experience for the user.

The information gathered from social networks can be user profile data, social data, purchase data, or a combination thereof. User profile data includes information that pertains specifically to the user. Social data includes information that pertains to the user's social networking contacts, or groups within the social network that include a subset of the user's contacts who share a common interest. Purchase data includes information pertaining to purchases made by the user or by the user's social network contacts. The information can be aggregated on a server computer in such a way that group information can be stored, and group statistics can be extracted from the stored data, while maintaining individuals'anonymity. An aggregate data set can then be used to generate a targeted advertisement for presentation by an advertising server to the user or the user's contacts, via an electronic device.

The foregoing and other objects, features, and advantages of the invention will become more apparent from the following detailed description, which proceeds with reference to the accompanying figures.

### BRIEF DESCRIPTION OF THE DRAWINGS

FIG. 1 is a block diagram of an exemplary system for delivering targeted advertising content to a user of an electronic device, based on information received from other users of a virtual social network.

FIG. 2 illustrates links between users and groups within an exemplary virtual social network.

FIG. 3 is an exemplary user interface configured to allow a user to authorize access to user profile data or social data from a social network.

FIG. 4 is a flow chart describing a generalized method for delivering targeted advertising content to the user.

FIG. 5 illustrates an example of the appearance of a device display on which an example of a targeted advertisement is being presented to the user.

FIG. 6 is a system diagram depicting an exemplary mobile device, including a variety of optional hardware and software components.

FIG. 7 is an exemplary user interface configured to allow a user to exclude access to purchase information about certain categories of purchase items.

FIG. 8 is a flow chart illustrating an alternative method of advertising to a target user via an electronic network.

FIG. 9 is a flow chart illustrating an alternative method of advertising to a target user's contacts via an electronic network.

FIG. 10 illustrates a generalized example of a suitable computing environment in which described embodiments, techniques, and technologies can be implemented.

### DETAILED DESCRIPTION

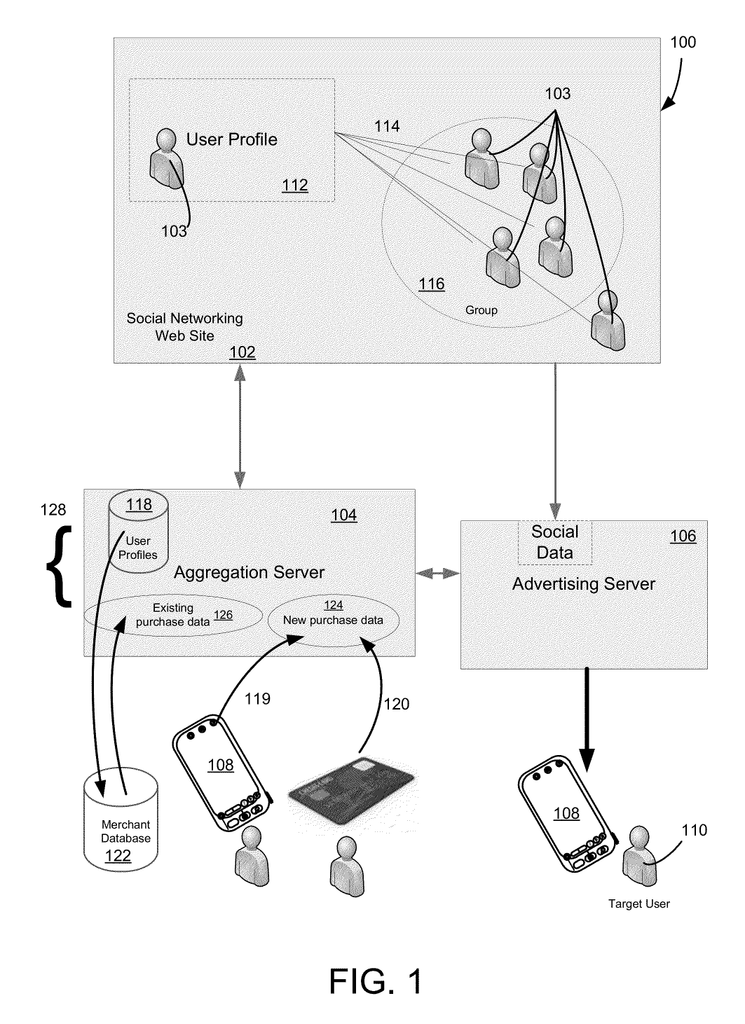

Turning to FIG. 1, an exemplary e-commerce system 100 is configured to facilitate cooperation between social networks and Internet retailers in suggesting purchase items to customers in the digital marketplace. The e-commerce system 100 can include components, such as a third-party social networking web site 102, that contain links (e.g., pointers) between a plurality of users 103; server computers including an aggregation server 104 that serves as a centralized data clearinghouse, an advertising server 106; and electronic devices 108 that can be used to transact purchases on the Internet. The aggregation server 104 can be operated by the social network provider, or it can be operated by a third party. The e-commerce system 100 generally serves to extract information from the third-party social networking web site 102, for the purpose of proposing purchase items through advertisements or presentations that are tailored to a target user 110. In this way, the e-commerce system 100 produces a dynamic marketplace that is tailored to the individual.

The social network established at the web site 102 generally provides a forum for users 103 to interact in writing, and/or by sharing images, videos, audio recordings, or other electronic means of communication. Typically, operation of such social networking web sites 102 is funded by advertisers and constitutes a business. Examples of existing social networking web sites include Facebook®, MySpace®, and LinkedIn®. Alternatively, more specialized social networking web sites can be established by non-business entities, such as, for example, non-profit agencies, professional societies, or universities. Or, a social networking web site can be operated as a web logging forum, or “blog,” in which users who share a common interest log conversations regarding certain topics, each topic constituting a thread.

Each of the users 103 of the social networking web site 102 is considered as an individual member, real or fictitious, of the social network community. A user identity can be established by a user submitting personal data in the form of a descriptive user profile 112. The user profile 112 can contain user identification information, purchase history data, social connection information (e.g. contacts), information derived from surveys or e-mail content, or demographic information, such as the user's age, marital status, educational level, address, family information, and the like. The user then can establish “links” 114 to other members of the social network who are known to the user, the linked members being designated as “contacts” or “friends.” The links 114 between users can be established by one user extending an invitation to another user, and receiving an acceptance. At that point, a database associated with the social network establishes pointers, at least between the sending user and the accepting user. A user can also be a member of a “group” 116. A group can be a subset of the user's contacts. Or a group can include other members that are not directly linked to a user, but only linked through the group. Thus, a user can establish primary links directly to other users, and secondary links that can be made via groups. For example, colleagues at the same workplace, sports team members, members of an arts community, families, and the like, can each form group associations. To enjoy meaningful participation in the social network, a user 103 has at least one link to a contact, but membership in one or more groups 116 is optional. In the example depicted in FIG. 1, a user having a user profile 112 has established links 114 to five other users 103, or contacts, four of whom are members of a common group 116, and one who is outside the group 116.

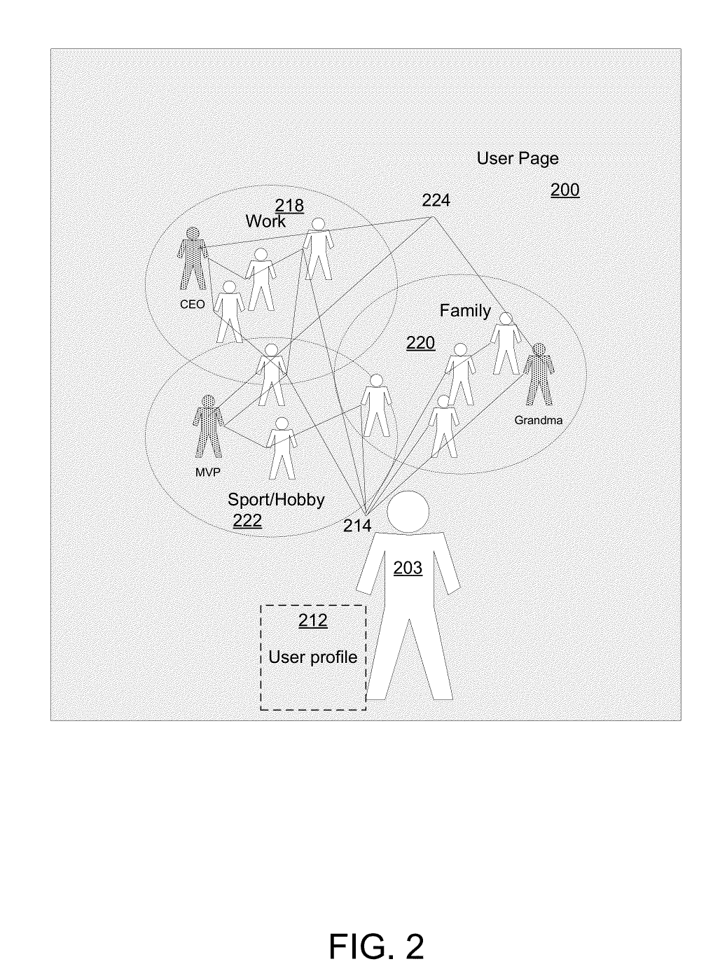

FIG. 2 depicts an exemplary set of links between users on a user page 200 at a social networking web site 102 in greater detail. A user 203 is typically identified by a descriptive user profile 212, and the user 203 typically connects to as many as about 150 other users via links 214 as described above in FIG. 1. Exemplary groups can include a work-related group 218, a family-related group 220, and a sport/hobby-related group 222. Within each group, certain users can be identified as having a perceived degree of influence over the other members of the group can be referred to as “primary influencers” 224. The primary influencers 224 tend to inspire behaviors, including purchase behaviors or similar consumer choices, in the other members of the group, who are generally followers. Examples of primary influencers 224 can be, for example, a corporate executive, a matriarch of a family, or a particularly highly skilled member, or “most valuable player,” of a sports team. Once the primary influencers 224 are identified, their choices can be used to promote purchase items to members of the group 216 even more effectively through targeted advertisements.

The e-commerce system 100 can be programmed to transmit data back and forth between the social networking web site 102 and the aggregation server 104. For example, user profiles 112 can be collected from the social networking web site 102, or from the mobile device 108, and stored by the aggregation server 104 in a user profile database 118.

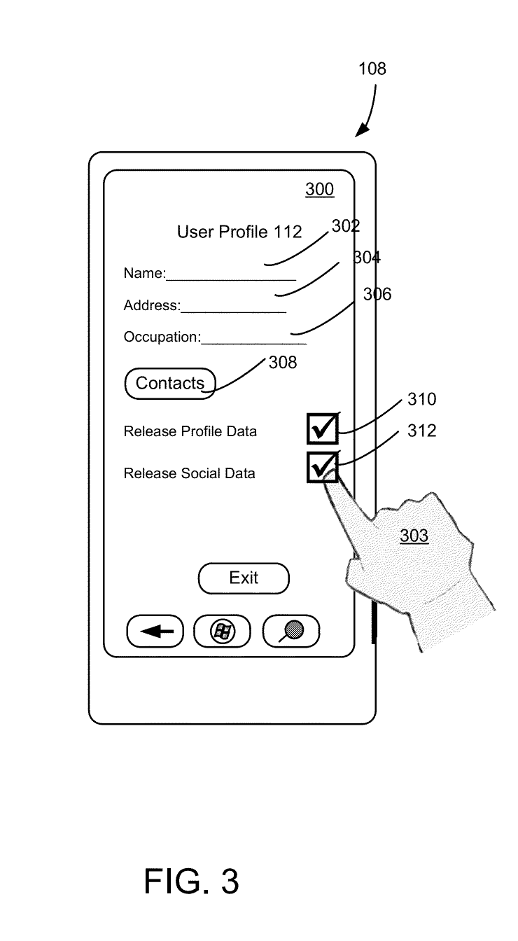

With reference to FIG. 3, a user profile interface page 300 typically allows editing the user profile 112 when a user 303 of the mobile device 108 accesses a social networking web site 102. User profile data 112 shown in FIG. 3 can include fields such as, for example, a name field 302, an address field 304, an occupation field 306, and the like. A contacts button 308 providing a convenient link to the user's contacts can also be accessible from the interface page 300.

Transfer of user profile data to third parties (e.g., retailers) outside the social network can be subject to active authorization by the user 303. For example, the user profile interface page 300 can provide a profile data check box 310 for the user 303 to direct release of user profile data 112 to the aggregation server 104. Alternatively, or in addition, the user profile interface page 300 can provide a social data check box 312 for the user 303 to authorize release of social data other than the user profile data 112. The social data can be released automatically, for example, to a specific retailer at the time of a sale.

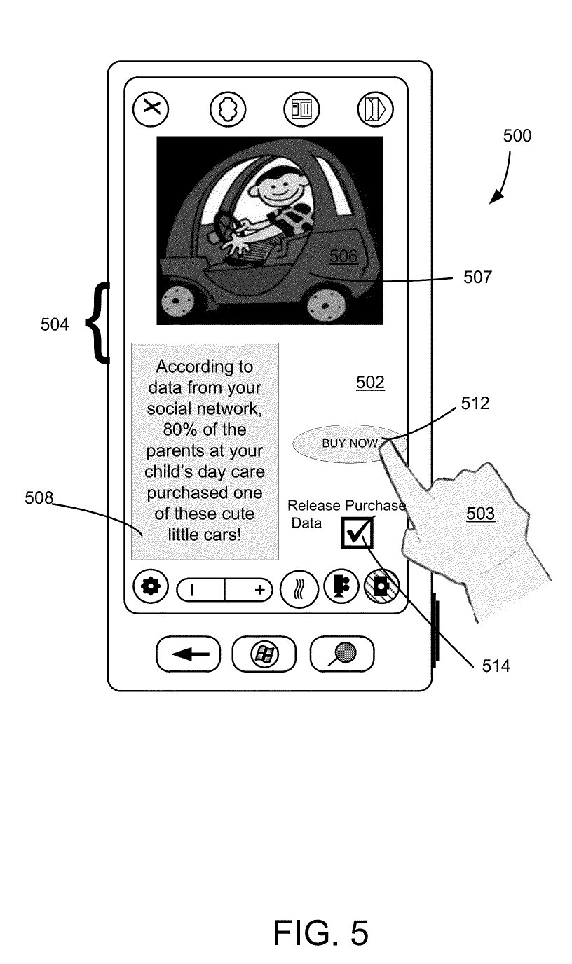

In addition to collecting user profiles 112, the aggregation server 104 is operable to gather and store purchase data when a user 103 of the social networking web site 102 completes a business transaction via the electronic device 108 or by simply using a credit card 120. The purchase data can be gathered as the transaction is taking place or after the transaction is complete. Purchase data typically resides on the electronic device 108 and/or in the merchant's database 122, from which it can be transferred and stored on the aggregation server 104. Collection of purchase data can also be subject to user authorization, for example, at the time of sale on a “per instance” basis, as shown in FIG. 5. Purchase information or purchasing behaviors (e.g., buying trends, frequented retailers, and the like) associated with a user's contacts can then become associated with, or part of, the stored user data in the user profile database 118. In any event, a user identification can be used to access a user profile 112 in database 118. And, using the user identification, data can be accessed from database 118 to obtain purchase information for the user's contacts in the social networking web site 102.

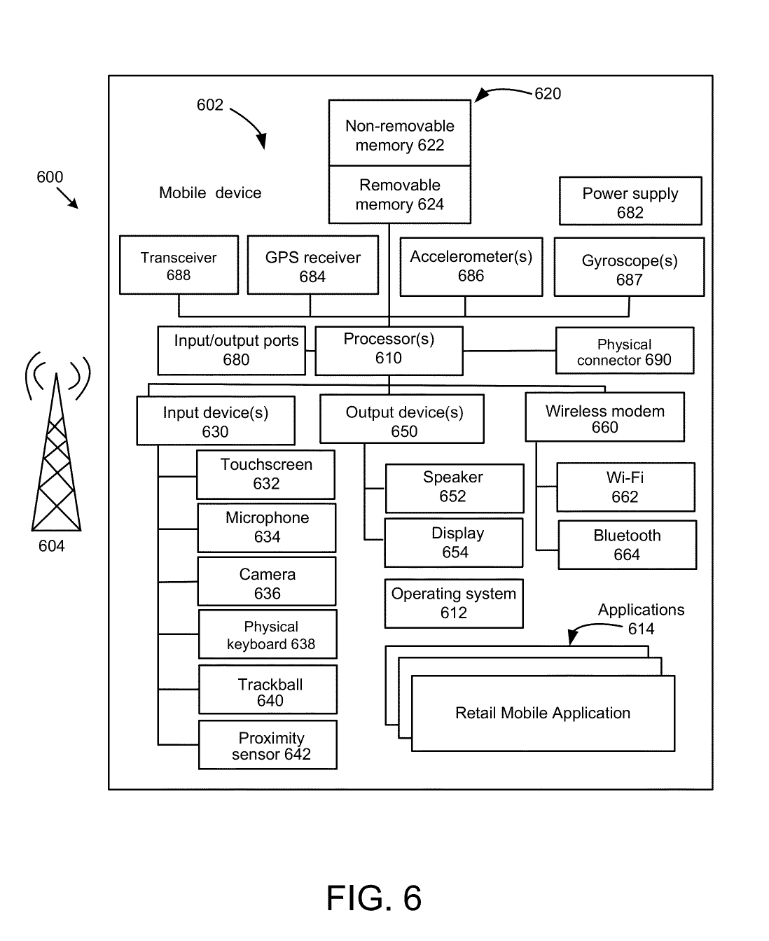

The electronic device 108 can be a mobile device, such as, for example, a smart phone, a laptop computer, or a tablet computer, or it can be a fixed device, such as a desktop computer or a television set-top box. The electronic device 108 is advantageously programmed with code for accessing the Internet and for conducting e-commerce transactions 119. If the electronic device 108 is a smart phone, the code can be in the form of a smart phone software application or “app” as described in FIG. 6 below. Furthermore, the aggregation server 104 can also be operable to collect new purchase data 124 when a user 103 of the social networking web site 102 completes a credit card transaction 120, whether the transaction 120 is conducted online, over the telephone, or in person at a retail merchant or service provider. Still further, the aggregation server 104 can be operable to retrieve existing purchase data 126 already collected in one or more merchant databases 122 associated with, for example, retailer programs, e.g., grocery store club cards, gift cards, rewards programs, frequent customer accounts, and the like. The user profiles 118, new purchase data 124, and existing purchase data 126, together comprise an information package, or aggregate data set 128. The data set 128 can be stored without associated identification of the users 103 so that the purchase data remains anonymous.

Furthermore, the e-commerce system 100 can be programmed to pass information back and forth between the aggregation server 104 (which can be the social networking site itself) and the advertising server 106. Such information can include portions of the aggregate data set 128, or alternatively, such information can be in the form of an advertisement. The advertising server 106 is advantageously programmed to generate tailored advertisements to the target user 110, based on the aggregated data stored in the aggregation server 104. Examples of tailored advertisements can be in the form of tailored emails or websites where products or services offered to the user are tailored based on their needs. The tailored advertisements can be presented to the target user 110 while the target user 110 is shopping at a particular online marketplace web site operated by an Internet-based retailer, or they can be presented to the target user 110 in the form of a customized “banner ad” displayed, for example, while browsing a web page at random anywhere on the Internet. A banner ad is well understood in the art to be an embedded advertisement in a webpage, typically sourced by a different server than the webpage itself, and used to attract traffic to the advertiser's website by enticing the user to select the banner ad. Once a banner ad is selected, an associated hyperlink is used to download additional information from the advertiser's server. In addition to a description of the purchase item, the targeted advertisement can include a discount offer that can be restricted to the target user 110 alone, or to a group 116 from the third-party social networking web site of which the target user 110 is a member, or to users 103 who share common user profile attributes (e.g., restricted by customer demographics). The target user 110 can be the same as any of the exemplary users 103 shown in FIG. 1.

According to another example, advertisements can be presented to a target user 110 who is located at a public forum in which there are mounted displays, such as a trade show, an airport, a shopping mall, or even to a target user 110 who is driving on a highway, alongside which one or more electronic billboards are installed. Presentation of the targeted advertisement can occur through any type of digital network-capable device, including a desktop computer, a laptop computer, a smart phone, a networked television, a television set-top box, a tablet device, an electronic billboard, and the like. Such a presentation can be facilitated by using, for example, GPS or FourSquare™ location information.

According to still another example, the advertising server 106 can generate a virtual direct-marketing storefront at which purchase items, culled from different retailers, that are predicted to be most likely to be purchased by the target user 110, can be brought together and presented as a customized marketplace that is tailored to the target user 110. In this example, the shopper is presented with a reduced set of options that can be carefully selected to better match the shopper's needs and interests.

By extending this example, observation of market trends in one location can be used to predict the likelihood of future purchases in another location, e.g., when a purchase item gains popularity on the east coast of the United States, the e-commerce system 100 can be used to predict the rise of sales on the west coast, as a sales trend sweeps across the country, similar to tracking the progress of an epidemic that “breaks out” and then propagates through a population.

According to still yet another example, the advertising server 106 can be associated with an online marketplace or an online retailer that has a select product range. Using an identification of a user, the online marketplace or retailer can access the user's profile from database 118. Purchases from other links in the user's social network can be used to generate targeted advertising to the user by determining which products currently available from the online marketplace or retailer were purchased by others linked to the user in the user's social network. Once the targeted advertising is generated, the user can be presented with an image of the product or products with a description that others in the user's social network have purchased this or these products.

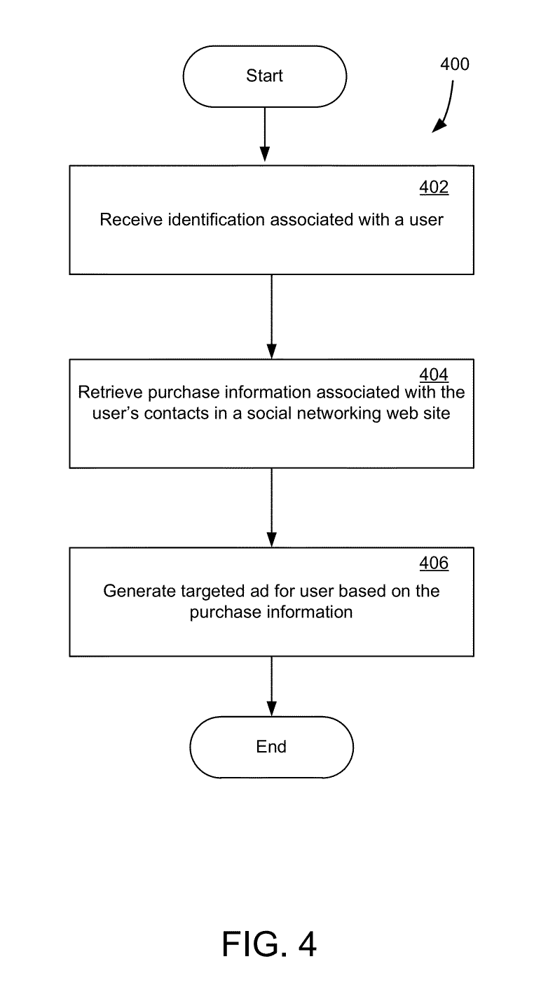

With reference to FIG. 4, an exemplary method 400 of delivering targeted advertising content to the target user 110 is shown as a sequence of generalized acts. First, the target user 110 of a third-party social networking web site 102 is identified (402), for example, while browsing a web site, or while attending a forum. User identification data can be entered by the user through a log-in process, or identification information can be passed to the server automatically through a cookie transferred by a client computer. After receiving the identification, purchase information can be retrieved (404) from one or more of the target user's social network contacts or groups 116 linked to the target user 110. The user's contacts and/or group affiliations can typically be found and accessed by the contacts via the user's social networking page, or group affiliations can be determined by filtering the user contacts according to one or more categories of shared interests. From the purchase information pertaining to the user's contacts, or to a subset of the user's contacts that are in a selected group 116, a targeted ad can then be generated (406) for presentation to the user. Further actions in the method 200 can include transmitting the targeted ad to a specific destination, such as an Internet retail site. Alternatively, the destination can be a delivery device, such as a display screen that the identified target user 110 is likely to see, or an audio message that the target user 110 is likely to hear, or some other method of delivery that allows the target user 110 to perceive the advertised message.

FIG. 5 shows an example of a display device in the form of a smart phone 500 equipped with a display screen 502 that can present to a target user 503 a targeted advertisement 504. The targeted advertisement 504 is thus an exemplary result of implementing the method described in FIG. 4. The targeted ad 504 can be a banner ad or it can be part of a customized marketplace in which the target user 503 is shown a limited selection of purchase items.

Upon identifying the target user 503 at a given web site, the display screen 502 can display one or more components of the targeted ad 504, such as, for example, an image 506 of a purchase item 507 offered for sale (in this case, a “kiddie car”), alongside advertising text 508. The targeted advertisement 504 can be generated by the aggregation server 104, and sent to the advertising server 106, or it can be generated by the advertising server 106, based on information supplied by the aggregation server 104. The “kiddie car” can be offered, for example, in the target user's favorite color, derived from the user profile or other social network information published to the aggregation server 104.

In the example shown in FIG. 5, suppose that the target user 503 is a parent of a young child, and that the target user 503 communicates regularly with other parents of young children at a social networking web site 102. Furthermore, suppose that the target user 503 is a member of a group 116 at the social networking web site 102, which group shares information about parenting. Based on purchase information collected from group members as described above (FIG. 1), the aggregation server 104 can determine that there is a purchase trend regarding kiddie cars like the one shown in the image 506. Statistics compiled by the aggregation server 104 describing the purchase trend can then be used to generate a text message 508, for example, based on peer purchasing behavior, for persuading the target user 503 to purchase the item.

Impulse purchases can be facilitated by providing a “buy now” button 512 that can complete a purchase transaction in one step using information previously authorized by the target user 503 for storage in the retailer's database. Thus, if the web page is a retail site that supports purchase transactions, the “buy now” button 512 provides a convenient opportunity to complete the sale immediately. Otherwise, if the web page does not support purchase transactions, the button 512 can re-direct the target user 503 to a retail web site that is configured to transact sales. Button 512 can be, for example, a touch screen button, a push button, a mouse-click button, or a selection capable of being chosen via a set-top box remote control device.

When a user buys the displayed item, purchase data can be passed back to the aggregation server 104 and stored in the user profile database 118. To maintain security of commercial data, a “release purchase data” check box 514 can be presented to the user 503 as part of a sales transaction. By checking the check box 514, the user 503 authorizes release of purchase data from the electronic device 108 back to the social networking web site 102 for use in updating statistics to motivate future purchases among contacts of the user 503 through ads such as advertisement 504. The purchase can be linked to the specific identification of the user, or it can be generically stored (anonymously) as being purchased by a member of the group.

In another example, the target user 503 can be a member of a sports team group 222, (e.g., a track team), and the targeted advertisement 504 can be directed to sales of sporting goods, (e.g., running shoes) determined to be popular among runners within the sports team group 222. In still another example, the target user 502 can be an employee of a corporation group 218 and the targeted advertisement 504 can be directed to sales of, for example, computer games frequently played by other employees of the same corporation group 218. Because individuals tend to trust other members of such groups, the advertisement 504 can be presumed to be more likely to result in a sale. In addition to tangible products, purchase items can take the form of, for example, software products, services, financial instruments, information, artistic content, entertainment, subscriptions, access to media, or memberships.

With reference to FIG. 6, a system diagram depicts an exemplary mobile device 600 including a variety of optional hardware and software components, shown generally at 602. Any component 602 in the mobile device can communicate with any other component, although not all connections are shown, for ease of illustration. The mobile device 600 can be any of a variety of computing devices (e.g., cell phone, smartphone, tablet computer, netbook, handheld computer, Personal Digital Assistant (PDA), or other such device) and can allow wireless two-way communications with one or more mobile communications networks 604, such as a cellular or satellite network.

The illustrated mobile device 600 can include one or more controllers or processors 610 (e.g., a signal processor, microprocessor, ASIC, or other control and processing logic circuitry) for performing such tasks as signal coding, data processing, input/output processing, power control, and/or other functions. An operating system 612 can control the allocation and usage of the components 602, including power states, and provide support for one or more application programs 614. The application programs 614 can include common mobile computing applications (e.g., email applications, calendars, contact managers, web browsers, messaging applications), an automatic image capture application according to the disclosed technology, or any other computing application. Additionally, a retail mobile application can be available that gathers purchase information and transmits the purchase information to the aggregation server 104. The aggregation server 104 can store the purchase information in association with a user identification in the user profile database 118.

The illustrated mobile device 600 includes memory 620. Memory 620 can include non-removable memory 622 and/or removable memory 624. The non-removable memory 622 can include RAM, ROM, flash memory, a hard disk, or other well-known memory storage technologies. The removable memory 624 can include flash memory, a Subscriber Identity Module (SIM) card, or other well-known memory storage technologies, such as “smart cards.” The memory 620 can be used for storing data and/or code for running the operating system 612 and the application programs 614. Exemplary data can include web pages, text, images, sound files, video data, or other data sets to be sent to and/or received from one or more network servers or other devices via one or more wired or wireless networks.

The mobile device 600 can support one or more input devices 630, such as a touchscreen 632, microphone 634, camera 636, physical keyboard 638, trackball 640, and/or proximity sensor 642, and one or more output devices 650, such as a speaker 652 and one or more displays 654. Other possible output devices (not shown) can include piezoelectric or haptic output devices. Some devices can serve more than one input/output function. For example, touchscreen 632 and display 654 can be combined into a single input/output device.

A wireless modem 660 can be coupled to an antenna (not shown) and can support two-way communications between the processor 610 and external devices, as is well understood in the art. The modem 660 is shown generically and can include a cellular modem for communicating with the mobile communication network 604 and/or other radio-based modems (e.g., Bluetooth 664 or Wi-Fi 662). The wireless modem 660 is typically configured for communication with one or more cellular networks, such as a GSM network for data and voice communications within a single cellular network, between cellular networks, or between the mobile device and a public switched telephone network (PSTN).

The mobile device can further include at least one input/output port 680, a power supply 682, a satellite navigation system receiver 684, such as a Global Positioning System (GPS) receiver, one or more accelerometers 686, one or more gyroscopes 687, and/or a physical connector 690, which can be a USB port, IEEE 4394 (FireWire) port, and/or RS-232 port. The accelerometer(s) 686 and/or the gyroscope(s) 687 can be implemented as micro-electro-mechanical systems (MEMS), which can be coupled to or embedded in an integrated circuit chip. The illustrated components 602 are not required or all-inclusive, as any components can be deleted and/or other components can be added.

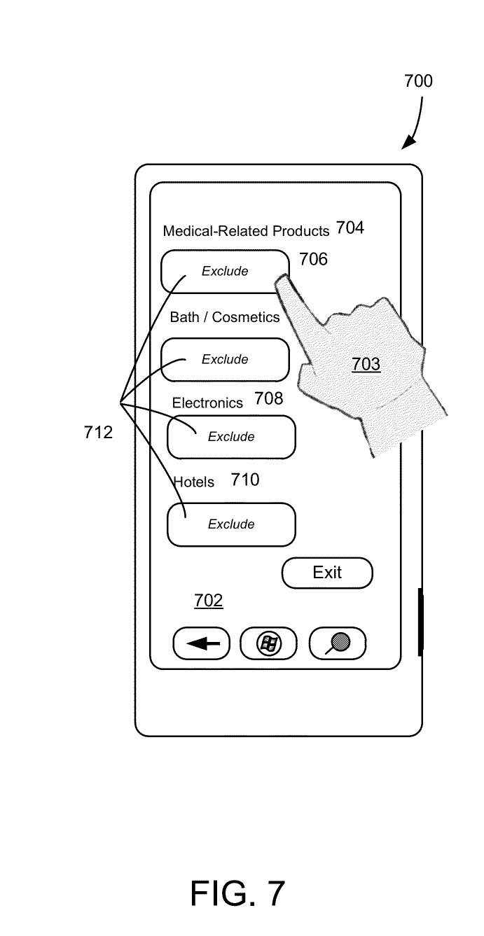

Turning now to FIG. 7, an exemplary configuration screen 700 is shown as a smart phone page 702 that allows a user 703 to exclude certain purchase information from being stored in association with the identifications of the users on the aggregation server 104, so that the purchase information remains anonymous. Although the aggregate data set 128 can comprise purchase information that is stored separately from user information, use of the configuration screen 700 feature provides users 703 with additional reassurance regarding network security. The user can choose to exclude this purchase information from their social networking groups, or the user can choose to allow a retailer to share the purchase information anonymously with other unknown users who share demographic characteristics.

Examples of purchase item types that users 703 may wish to selectively exclude from the aggregate data set 128 can be, for example, medical products 704, such as prescription drugs, medical supplies, nutritional supplements, and the like; health and beauty aids 706 including cosmetics, personal care items, over-the-counter medication, and the like; electronics 708; or hotels 710 that could reveal a user's whereabouts while on vacation for example, thereby constituting an invasion of privacy. These or other purchase item categories or types can be selectively excluded from being sent to the aggregation server 104. Alternatively, such purchase items can be included in the aggregated data set 128 in association with a common group instead of being associated with individual users, by activating an “exclude” touchscreen button 712, for example. If the user is accessing the system 100 via a different type of device other than a smart phone, the configuration screen 700 can be a window on a computer, a set-top box screen, or the like.

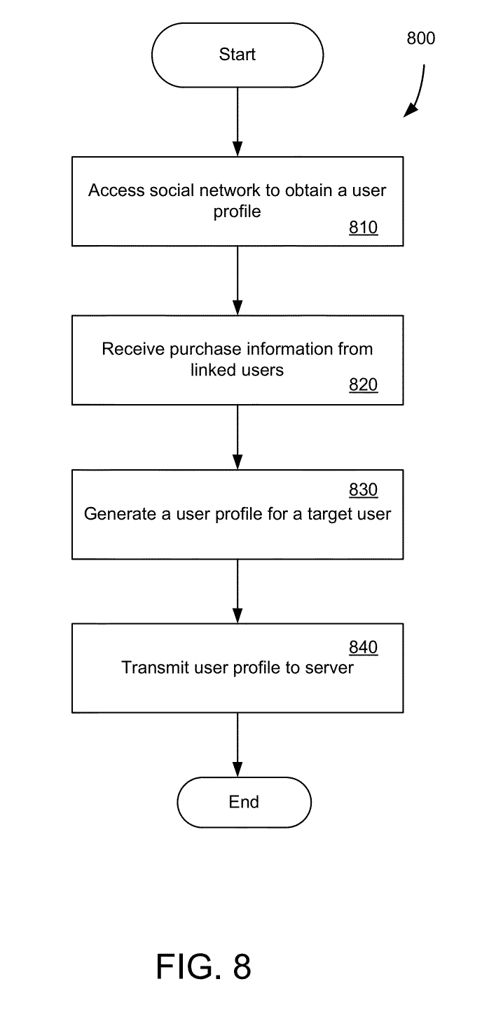

With reference to FIG. 8, an alternative method of targeted advertising is shown, in which a sequence of actions 800 is performed by the aggregation server 104. First, the aggregation server 104 can access (810) the social network web site 102 to obtain a user profile, which can include links to contacts of the target user and/or personal information. Next, the aggregation server 104 can receive (820) purchase information about and from the linked users 103. Next, the aggregation server can generate (830) a user profile 112 for the target user 110 using the contacts' purchase information. The user profile can include a group and contacts linked to the target user through the group. Finally, the aggregation server 104 can transmit (840) the user profile 112 to the advertising server 106.

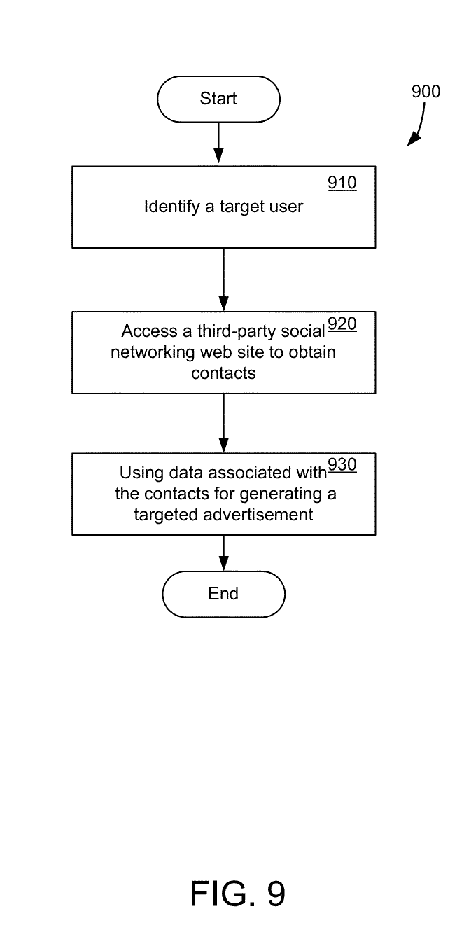

With reference to FIG. 9, another method of targeted advertising 900 is shown. In process block 910, a target user is identified. For example, a user identification can be supplied to a server computer using a client device. The user identification can be a GUID or other identifier (e.g., such as a name and/or password). In process block 920, the third party social networking web site can be accessed automatically to obtain contacts linked to the user identification. In process block 930, data associated with the contacts can be used to generate a targeted advertisement. The data can be passed to an advertising server for purposes of analyzing the data in view of available products from the advertising server. Or, the data can be used for generating banner ads. In this example, “using” can include generating a user profile for the target user and transmitting the user profile to an online marketplace web site. The online marketplace web site can then generate a targeted advertisement and present the targeted advertisement to the [same] user.

According to another example, the targeted advertisement can also potentially be presented to multiple new target customers at Internet retailers, for each known customer. For example, a user profile 112 can be generated for one or more of the user's contacts, so that an ad can be targeted for presentation to each of said contacts upon identifying the contact's presence at an Internet web site. In this example, the power of the social network to streamline the advertising process is realized. Instead of simply advertising for repeat sales to existing customers, an Internet retailer can gain access to those customers' social networking contacts who share similar interests, and who are therefore more likely to be receptive to the ad. This example of Internet-based advertising constitutes a digital version of traditional “direct marketing” schemes. However, the digital version is executed automatically, without a need for active marketing participation by the user.

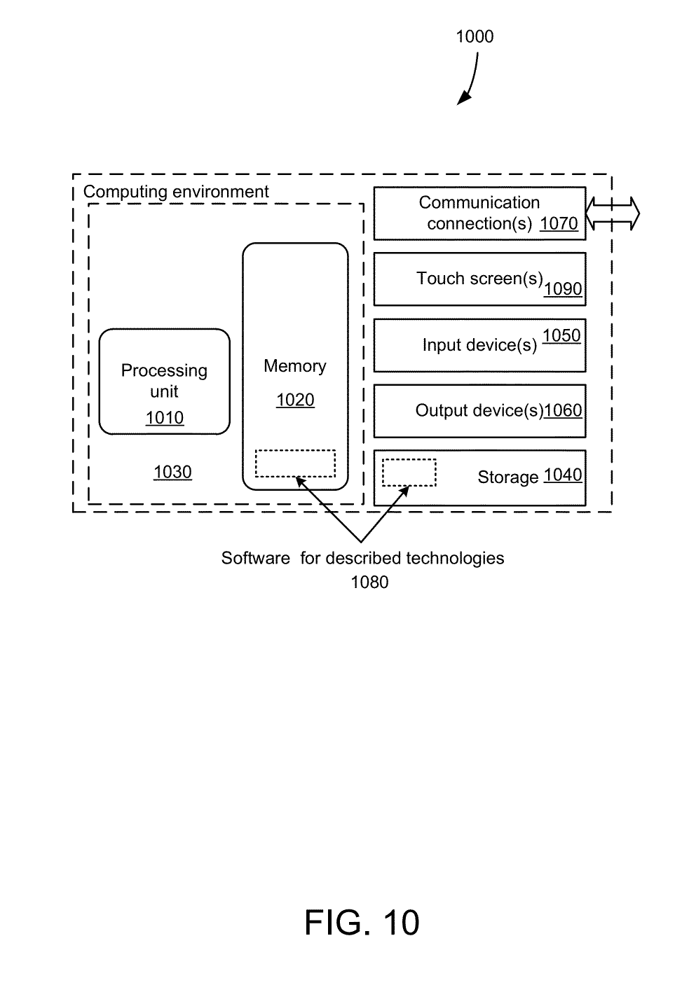

FIG. 10 illustrates a generalized example of a suitable computing environment 1000 for the servers described, in which embodiments of the disclosed technology can be implemented. For example, the computing environment 1000 can apply to the aggregation server 104, and/or to the advertising server 106. With reference to FIG. 10, the computing environment 1000 includes at least one central processing unit 1010 and a memory 1020. In FIG. 10, this most basic configuration 1030 is included within a dashed line. The central processing unit 1010 executes computer-executable instructions and can be a real or a virtual processor. In a multi-processing system, multiple processing units execute computer-executable instructions to increase processing power and as such, multiple processors can be running simultaneously. The memory 1020 can be volatile memory (e.g., registers, cache, RAM), non-volatile memory (e.g., ROM, EEPROM, flash memory, etc.), or some combination of the two. The memory 1020 stores software 1080 that can, for example, implement the technologies described herein. A computing environment can have additional features. For example, the computing environment 1000 includes storage 1040, one or more input devices 1050, one or more output devices 1060, one or more communication connections 1070, and one or more touchscreens 1090. An interconnection mechanism (not shown), such as a bus, a controller, or a network, interconnects the components of the computing environment 1000. Typically, operating system software (not shown) provides an operating environment for other software executing in the computing environment 1000, and coordinates activities of the components of the computing environment 1000.

The storage 1040 can be removable or non-removable, and includes magnetic disks, magnetic tapes or cassettes, CD-ROMs, CD-RWs, DVDs, or any other non-transitory storage medium which can be used to store information and that can be accessed within the computing environment 1000. The storage 1040 stores instructions for the software 1080, which can implement technologies described herein.

The input device(s) 1050 can be a touch input device, such as a touchscreen, keyboard, keypad, mouse, pen, or trackball, a voice input device, a scanning device, proximity sensor, image-capture device, or another device, that provides input to the computing environment 1000. For audio, the input device(s) 1050 can be a sound card or similar device that accepts audio input in analog or digital form. The output device(s) 1060 can be a display, touchscreen, printer, speaker, CD-writer, or another device that provides output from the computing environment 1000. The touchscreen 1090 can act as an input device (e.g., by receiving touchscreen input) and as an output device (e.g., by displaying an image capture application and authentication interfaces).

The communication connection(s) 1070 enable communication over a communication medium (e.g., a connecting network) to another computing entity. The communication medium conveys information, such as computer-executable instructions, compressed graphics information, or other data in a modulated data signal.

Computer-readable media are any available media that can be accessed within a computing environment 1000. By way of example, and not limitation, with the computing environment 1000, computer-readable media include memory 1020 and/or storage 1040. As should be readily understood, the term computer-readable storage media includes non-transitory storage media for data storage, such as memory 1020 and storage 1040, and not transmission media, such as modulated data signals.

In view of the many possible embodiments to which the principles of the disclosed invention can be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method of advertising on a digital network, comprising:
receiving, on a server computer, an identification associated with a user of a third-party social networking web site;
using the identification, retrieving purchase information associated with user contacts who are linked to the user through the third-party social networking web site; and
generating targeted advertising to be presented to the user based on at least the purchase information of the user contacts.

2. The method of claim 1, further including:
selecting at least one group from a plurality of groups on a user's page of the third-party social networking web site; and
wherein retrieving purchase information only applies to the user contacts that are in the selected group.

3. The method of claim 1, wherein the targeted advertising is a banner ad displayed on a web page.

4. The method of claim 1, wherein the targeted advertising is presented to the user in the form of a virtual retail marketplace whose appearance and purchase items offered for sale are tailored to the user to provide a customized shopping experience.

5. The method of claim 4, further including transmitting purchase data from the online marketplace web site to an aggregation server that stores the purchase data in association with other data from the third-party social networking web site.

6. The method of claim 1, further including receiving purchase information using an application on a mobile phone and transmitting the purchase information to an aggregation server that stores the purchase information in association with the identification of the user.

7. The method of claim 1, wherein the user can selectively exclude purchase information from being received based on purchase item type.

8. The method of claim 1, further including:
receiving purchase information associated with users of the third-party social networking web site;
identifying a common group among the users using linking information in the third-party social networking web site; and
storing in a database the received purchase information in association with the common group, but without identifications of the users so that the purchase information is anonymous.

9. The method of claim 1, further including generating a user profile associated with the user, the user profile including the purchase information associated with the user's contacts through the third-party social networking web site.

10. A computer-readable storage device that includes computer-executable instructions for causing a computing device programmed thereby to perform a method comprising:
identifying a target user for whom a targeted advertisement can be generated;
accessing a third-party social networking web site to obtain contacts who are linked to the target user; and
using data associated with the contacts for the purpose of generating a targeted advertisement.

11. The computer-readable storage device of claim 10, wherein the data associated with the contacts includes purchasing behaviors of the contacts.

12. The computer-readable storage device of claim 11, further including selectively excluding certain purchase items from being included in the data.

13. The computer-readable storage device of claim 10, further including identifying a group from the third-party social networking web site and wherein the generation of the targeted advertisement includes selecting a purchase item for the targeted advertisement that was purchased by other users in the group, wherein the group comprises a subset of the target user's contacts.

14. The computer-readable storage device of claim 10, wherein the using of the data further includes:
generating a user profile for the target user;
transmitting the user profile to an online marketplace web site;
generating the targeted advertisement; and
presenting the targeted advertisement to the target user.

15. The computer-readable storage device of claim 10, further including generating a banner ad as the targeted advertisement for the current user.

16. The computer-readable storage device of claim 10, wherein the data includes purchase data and further including aggregating the purchase data for a user's contacts and storing the purchase data without associated identification of the contacts so that the purchase data is anonymous.

17. A method of advertising on a network, comprising:
using a server computer, accessing a third-party social networking web site to obtain a user profile associated with a target user, wherein the user profile includes links to contacts of the target user through the third-party social networking web site;
receiving, on the server computer, purchase information associated with one or more contacts linked to the target user;
generating a user profile for the target user using at least the contacts' purchase information; and
transmitting the user profile to a server for generating targeted advertising.

18. The method of claim 17, wherein the user profile further includes personal information of the target user.

19. The method of claim 17, wherein the user profile includes a group and contacts linked to the target user through the group, wherein the purchase information is only shared with contacts linked to the target user through the group.

20. The method of claim 17, further including selecting one or more target customers from the contacts identified within the social networking web site; and
proposing purchase items to the target customers via an electronic device.
